(19) United States
(12) Patent Application Publication
(10) Pub. No.: US 2017/0080514 A1
(43) Pub. Date: Mar. 23, 2017

(54) INSULATOR FOR WELDING A BOSS ONTO A MEMBER

(71) Applicant: Caterpillar Inc., Peoria, IL (US)

(72) Inventors: Tad W. Miller, Oreana, IL (US); Steven M. Swartzel, East Peoria, IL (US); Richard J. La Reau, Decatur, IL (US)

(73) Assignee: Caterpillar Inc., Peoria, IL (US)

(21) Appl. No.: 14/856,609

(22) Filed: Sep. 17, 2015

(51) Int. Cl. B23K 11/16; B23K 11/36; B23K 11/11

(52) U.S. Cl. CPC B23K 11/16; B23K 11/11; B23K 11/36

(57) ABSTRACT

An insulator for welding a boss onto a member is provided. The insulator includes a body comprising a first surface and a second surface. The second surface includes a first curved profile. The insulator also includes a bore extending between the first surface and the second surface to define an inner wall of the body. The insulator further includes a protrusion in the inner wall proximal to the second surface. The protrusion, in the insulator, includes a second curved profile.

### TECHNICAL FIELD

The present disclosure relates to an insulator, and more particularly to an insulator for welding a boss onto a member and a method of welding a boss onto a member.

### BACKGROUND

Typically, a boss is fixed onto a member using welding techniques. Such welding techniques employ insulators to support the boss onto the member during the welding process. Currently available insulators are designed for flat surfaces, which may not be suitable for welding a boss to structures with non-flat surfaces, such as curved and tubular surfaces.

U.S. Pat. No. 7,026,568, (the '568 patent) discloses a weld insulator and a metal weld gear used in an orbital welding heads and welding systems for welding pipe and tubing butt joints. The '568 patent discloses that the metal weld gear consists of a substantially semi-circular recess formed within and the insulator nested within said substantially semi-circular recess. The '568 patent may not be particularly suitable for welding a boss onto a structure with a non-flat surface.

### SUMMARY OF THE INVENTION

In one aspect of the present disclosure, an insulator for welding a boss onto a member is described. The insulator includes a body comprising a first surface and a second surface. The second surface includes a first curved profile. The insulator also includes a bore extending between the first surface and the second surface to define an inner wall of the body. The insulator further includes a protrusion in the inner wall proximal to the second surface. The protrusion includes a second curved profile.

In another aspect of the present disclosure, a method of welding a boss onto a member is described. The method includes providing an insulator. The insulator includes a body comprising a first surface and a second surface. The second surface includes a first curved profile. The insulator also includes a bore extending between the first surface and the second surface to define an inner wall of the body. The insulator further includes a protrusion in the inner wall proximal to the second surface. The protrusion includes a second curved profile. The method further includes placing the insulator with the second surface in contact with the member. The method also includes supporting the boss, along a longitudinal axis, inside the bore of the insulator. The method further includes forming a weld joint between the boss and the member.

In yet another aspect of the present disclosure, an insulator for welding a boss onto a curved surface of a member is described. The insulator includes a body having a first section and a second section. The first section includes a first surface and the second section includes a second surface, respectively. The second surface includes a first curved profile. The insulator also includes a plurality of ridges defined in at least a portion of the second surface. The plurality of ridges is substantially semi-circular in shape. The insulator further includes a bore extending between the first surface and the second surface to define an inner wall of the body. The insulator includes a protrusion in the inner wall proximal to the second surface. The protrusion includes a second curved profile.

Other features and aspects of this disclosure will be apparent from the following description and the accompanying drawings.

### BRIEF DESCRIPTION OF THE DRAWINGS

FIG. 1 is a perspective view of an insulator for welding a boss onto a member, according to one embodiment of the present disclosure;

FIG. 2 is a planar view of the insulator, according to one embodiment of the present disclosure;

FIG. 3 is a sectional view of the insulator, according to one embodiment of the present disclosure;

FIG. 4 is a partial perspective view of an exemplary frame employing the insulator for welding the boss onto the member, according to one embodiment of the present disclosure.

FIG. 5 is a block diagram depicting a method of welding a boss onto a member, according to one embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

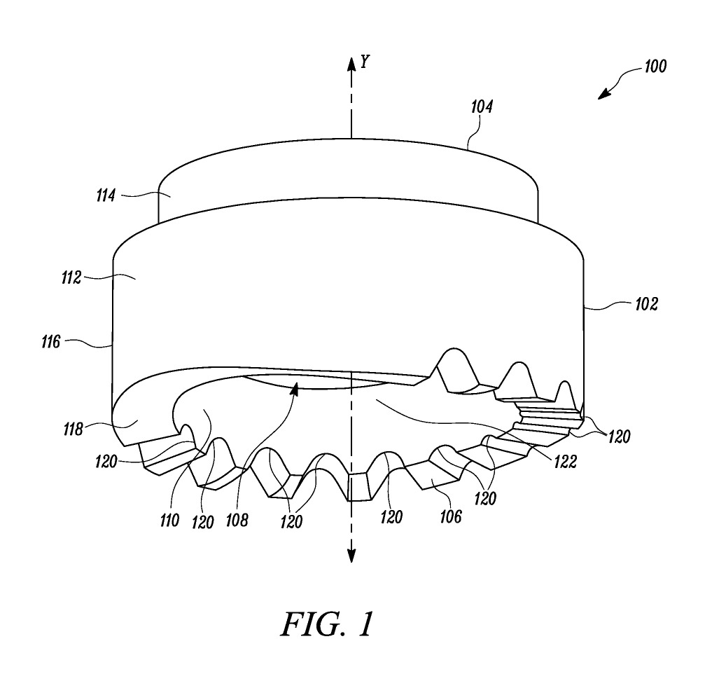

FIG. 1 is a perspective view of an insulator 100, according to one embodiment of the present disclosure. The insulator 100 may be employed for welding a boss onto a member. It may be understood that the insulator 100 may be utilized for supporting the boss onto the member during the welding process. The insulator 100 may be employed for welding bosses to a member in a frame of wheel tractor scrapers, off-highway trucks and large mining trucks and so on. In particular, the insulator 100 may be employed for welding bosses to a member on a curved surface in a frame. In an exemplary embodiment, the welding process employed for attaching the boss onto the member may include one of many resistive welding techniques known in the art.

As illustrated in FIG. 1, the insulator 100 includes a body 102. In an embodiment, the body 102 of the insulator 100 may be made of a ceramic material, such as, but not limited to, steatite, cordierite, alumina, zirconia, etc. The ceramic material may allow the insulator 100 to possess high strength and ability to withstand high temperatures. Further, the body 102 may be formed by any suitable process such as, but not limited to, sintering, molding and the like. The body 102, being made of ceramic material, may adapt the insulator 100 to be employed in applications that require rigid components having electrically non-conductive and/or heat dissipating properties.

In an embodiment, the body 102 may be substantially cylindrical in shape. The body 102 may include a first surface 104 and a second surface 106. It may be contemplated from the figures, that the first surface 104 may be a top surface for the body 102 and the second surface 106 may be a bottom surface for the body 102, respectively. In particular, the body 102 may be in the shape of a hollow cylinder. The insulator 100 may include a bore 108 extending between the first surface 104 and the second surface 106. The bore 108 may define an inner wall 121 and an outer wall 112 of the body 102. It may be understood that the separation between the inner wall 121 and the outer wall 112 defines a width for the body 102. The insulator 100 may be configured to support the boss inside the bore 108 along a longitudinal axis ‘Y’ for the purpose of welding the boss onto the member.

In one embodiment, the body 102 may include two sections, a first section 114 and a second section 116. In one example, the body 102, including the first section 114 and the second section 116, may be formed as a unitary structure. In another example, the first section 114 and the second section 116 may be formed separately and then joined together to form the body 102 by any suitable joining means known in the art. The first section 114 may be arranged above the second section 116, co-axial to each other along the longitudinal axis ‘Y’. Also it may be contemplated that the first surface 104 may form a part of the first section 114 and the second surface 106 may form a part of the second section 116.

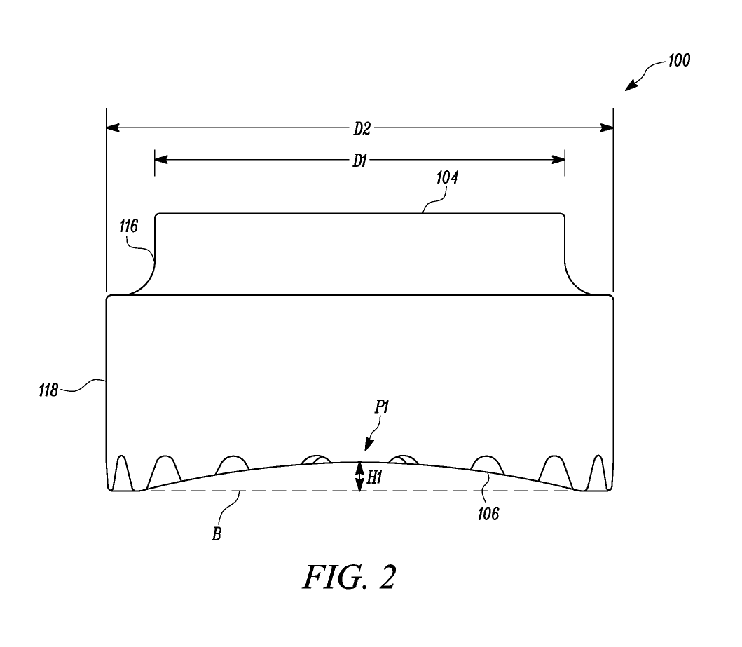

Referring to FIG. 2, as illustrated, it may be seen that the first section 114 and the second section 116 may be of different sizes, with the first section 114 having a first diameter ‘D1’ and the second section 116 having a second diameter ‘D2’. In one example, as illustrated, the second diameter ‘D2’ may be greater than the first diameter ‘D1’.

In an embodiment of the present disclosure, the second surface 106 of the insulator 100 may include a first curved profile 118, as illustrated in FIGS. 1-2. In other words, the second surface 106 may be in the shape of the first curved profile 118. The first curved profile 118 may occupy a portion of the second section 116 of the insulator 100. In the planar view, as illustrated in FIG. 2, the first curved profile 118 may be seen as an arc defined in the second section 116 of the insulator 100. The first curved profile 118 may have a pre-designed curvature defined in terms of a height ‘H1’ with respect to the second diameter ‘D2’ of the second section 116, where the height ‘H1’ may be measured as a distance between a peak point ‘P1’ of the first curved profile 118 and a base surface ‘B’, when the insulator 100 is placed on the base surface ‘B’ in a rest position.

The second surface 106 of the insulator 100 may include a plurality of ridges 120. As more clearly illustrated in FIG. 1, the plurality of ridges 120 may be disposed in a portion of the periphery/circumference of the second surface 106. The plurality of ridges 120 may be disposed in substantially a half portion of the periphery/circumference of the second surface 106. In one example, the ridges 120 may be formed integral to the second section 116, for example, while sintering, molding and the like. In other example, the ridges 120 may be formed by removing a portion from the second section 116 of the body 102, proximal to the second surface 106.

The plurality of ridges 120 may be substantially semicircular in shape. However, it may be contemplated that the plurality of ridges 120 may be of any other suitable shape like triangular, rectangular or the like. It may be understood that the ridges 120 may have a curvature, generally, greater than the curvature of the first curved profile 118. The ridges 120 may be configured to vent any gases that may be present inside the insulator 100. A radius of curvature for the ridges 120 may be smaller or larger depending on the venting requirements of the insulator 100. In one example, the ridges 120, in the plurality of ridges 120, may have different radius of curvatures.

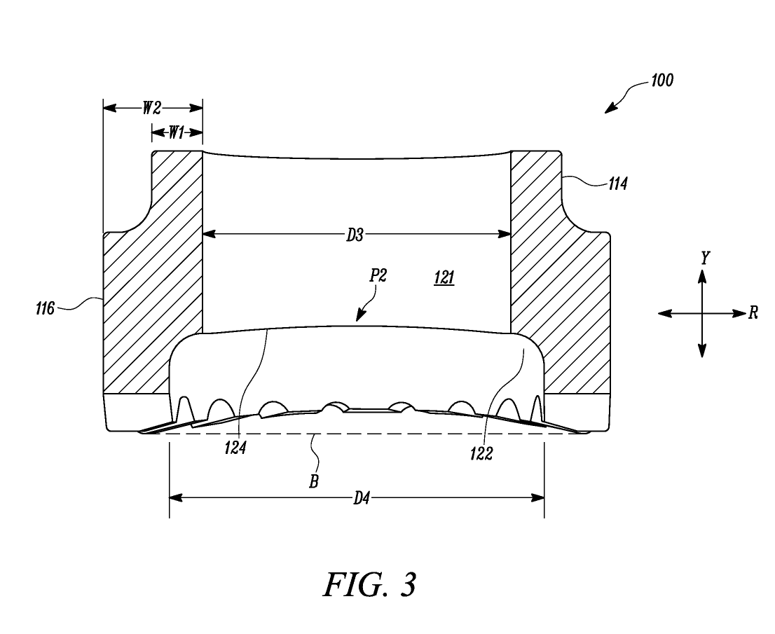

Referring to FIG. 3, a sectional view of the insulator 100 along a plane incorporating the longitudinal axis ‘Y’ is illustrated. As depicted, the first section 114 and the second section 116 may have an inner diameter ‘D3’. The equivalent inner diameter ‘D3’ for the first section 114 and the second section 116 provides a continuous inner wall 121 in the body 102 of the insulator 100. Alternatively, the inner diameter for the first section 114 and the second section 116 may be different. Further, as illustrated, the width of the body 102 may vary between the first section 114 and the second section 116. In one example, the first section 114 may have a width ‘W1’ and the second section 116 may have a width ‘W2’. Again, the width ‘W2’ of the second section 116 may be greater than the width ‘W1’ of the first section 114. It may be contemplated that this in turn contributes towards the second diameter ‘D2’ being greater than the first diameter ‘D1’. In one example, the first section 114 and the second section 116 may have equal width providing a smooth outer wall 112.

In an embodiment, the insulator 100 may include a protrusion 122 defined in the inner wall 121 of the body 102. The protrusion 122 may be disposed in the second section 116 of the insulator 100. In particular, the protrusion 122 may be located proximal to the second surface 106 of the insulator 100. In one example, the protrusion 122 may be formed integral to the second section 116, for example, while sintering, molding and the like. In other example, the protrusion 122 may be formed by removing a portion from the inner wall 121 of the second section 116 proximal to the second surface 106.

The protrusion 122 may be extending along a radial axis ‘R’ as well as the longitudinal axis ‘Y’ in the inner wall 121 of the insulator 100. In the direction of radial axis ‘R’, as illustrated in FIG. 3, the protrusion 122 may be seen to extend beyond the inner diameter ‘D3’ of the second section 116, defining an inner diameter ‘D4’ for the protrusion 122. The protrusion 122 may extend to a height ‘H2’, below an edge formed between intersection of the first section 114 and the second section 116.

Further, in an embodiment, the protrusion 122 defines a second curved profile 124 in the inner wall 121 of the insulator 100. The second curved profile 124 may occupy a portion in the inner wall 121 of the second section 116. In the sectional view, as illustrated in FIG. 3, the second curved profile 124 may be an arc defined in the inner wall 121 of the insulator 100. The second curved profile 124 may have a pre-designed curvature defined in terms of the height ‘H2’ with respect to the inner diameter ‘D4’ of the protrusion 122, where the height ‘H2’ may be measured as a distance between a peak point ‘P2’ of the second curved profile 124 and the base surface ‘B’, when the insulator 100 is placed on the base surface ‘B’ in a rest position.

In an embodiment of present disclosure, the second curved profile 124 of the protrusion 122 may be identical to the first curved profile 118 of the second surface 106. That is, the curvature of the second curved profile 124 may be substantially equivalent to the curvature of the first curved profile 118. The curvatures described above are for purposes of illustration and may be changed according to other requirements. For example, the second curved profile 124 may have a different curvature with respect to the first curved profile 118 based on the requirement and location of implementation of the insulator 100.

### INDUSTRIAL APPLICABILITY

As described earlier, an insulator is placed on a member in contact with a member for the purpose of welding a boss onto the member, where the boss is supported in a bore of the insulator. Thereafter, the boss is heated to a weld temperature, as required in a resistive welding process, such that the boss may start to melt at its bottom and form a weld joint with the member. However, in some cases, the member may have a curved surface to which the boss is to be welded. In such cases, when an insulator, with a second surface having a flat profile, is placed onto the curved surface of the member, there may be gaps along an inner wall of the insulator, between the curved surface and the second surface of the insulator, which may result in an improper weld joint. Further, the weld joint formed may inherently have less weld throat thickness, as there may be no space for the melted liquid to accumulate during the formation of the weld joint inside of the insulator.

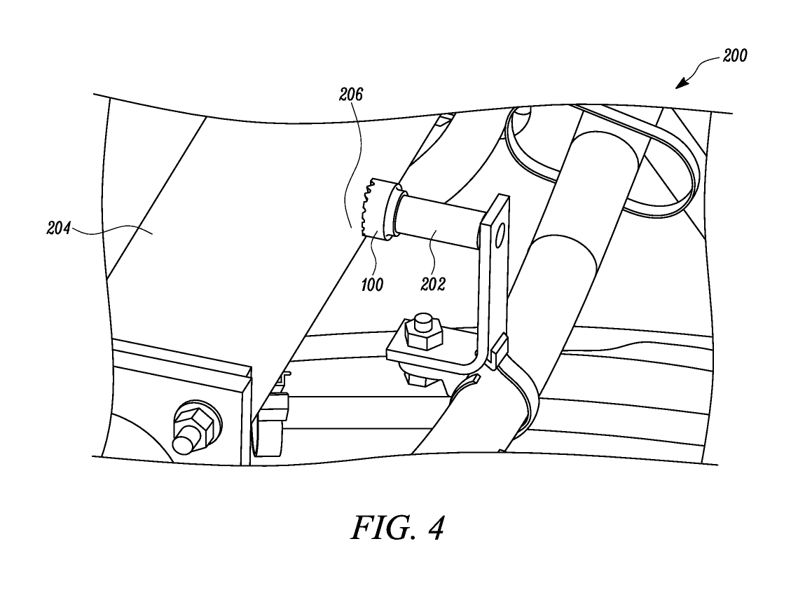

FIG. 4 illustrates a frame 200 implementing the insulator 100 for welding a boss 202 onto a member 204, according to an embodiment of the present disclosure. The frame 200 may be a frame of a machine, such as a wheel loader, an off-highway truck, a mining truck, etc. The frame 200 may be configured to support various components in the machine. As illustrated, the bosses 202 may be attached to the members 204 of the frame 200. The bosses 202 may support the various lines, such as hydraulic and electrical lines, which enable the functionality of the corresponding machinery and/or systems. For such applications, it may be necessary for the bosses 202 to be firmly welded to the members 204 of the frame 200.

In some situations, the member 204 may be a curved or a tubular member having a curved surface 206. From illustration of FIG. 4, it may be contemplated by a person skilled in the art that for attaching the boss 202 to the member 204, firstly the insulator 100 is disposed onto the curved surface 206 of the member 204 with the second surface 106 in contact therewith, subsequently the boss 202 is supported inside the bore 108 of the insulator 100, and thereafter the boss 202 is welded onto the curved surface 206 of the member 204, using any of the suitable resistive welding techniques known in the art.

The second surface 106 of the present disclosure may be designed to have the first curved profile 118 which adapts the insulator 100 to sit closely onto the curved surface 206 of the member 204. The first curved profile 118, as defined in the second surface 106, may be designed to conform to the curved surface 206. The first curved profile 118 may reduce the gaps formed between the insulator 100 and the member 204, when the insulator 100 is placed thereon for welding process, and therefore results in a more proper weld joint formed between the boss 202 and the member 204. Further the protrusion 122, in the insulator 100, may provide more free space in the region where the boss 202 is in contact with the member 204, and particularly along the inner wall 121. This space may allow for the melted liquid from the boss 202 to accumulate evenly above the curved surface 206. Furthermore, the second curved profile 124 of the protrusion 122 allows for the molten liquid to rise to a uniform height above the curved surface 206, resulting in a weld joint with uniform throat thickness. In other words, the protrusion 122 in the insulator 100 provides a curved profile for the formed weld joint outlining the second curved profile 124, and thus form a weld joint with uniform throat thickness.

It may also be contemplated that during the welding process, the temperature of the gases inside the insulator 100 may rise. The plurality of ridges 120 may help to vent out such hot gases from inside of the insulator 100, thus regulating heat and providing air circulation for welding process. Further, the ceramic material used for the insulator 100 provides high electrical strength and high thermal resistance to withstand the conditions during the welding process. As after the welding process is completed, the insulator 100 is removed and discarded, the use of ceramic materials further make the insulator 100 more environment friendly. The first curved profile 118 may further provide an improved shield during the welding process. From the above discussion it may be understood that the insulator 100 of the present disclosure may be employed for welding the boss 202 onto the member 204 for reducing stress and fatigue in the formed weld joint.

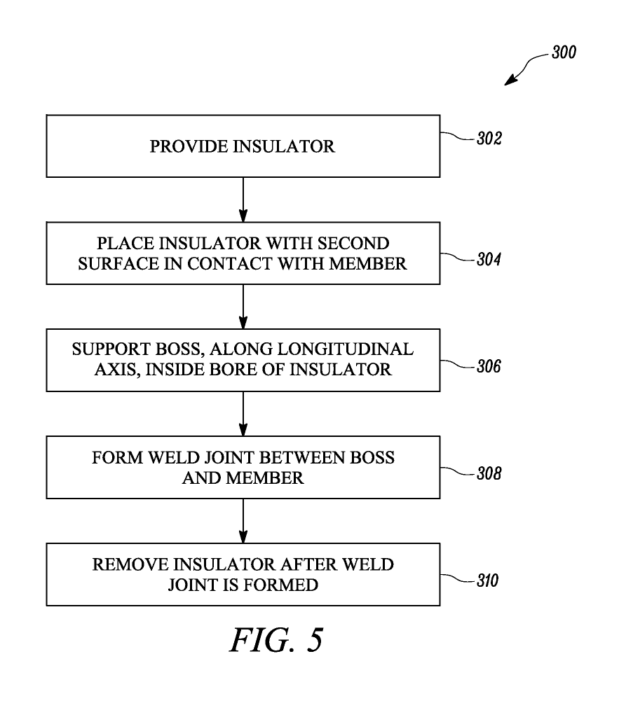

FIG. 5 is a flow diagram depicting a method 300 for welding the boss 202 onto the member 204, according to one embodiment of the present disclosure. In step 302, an insulator 100 of the present disclosure is provided for the welding purpose. The insulator 100 is placed in such a way that the second surface 106 may be in contact with the member 204, as indicated in step 304. In step 306, the boss 202 is supported along the longitudinal axis ‘Y’ inside the bore 108 of the insulator 100. In step 308, the weld joint is formed between the boss 202 and the member 204 by heating the boss 202 to at least a weld temperature. In step 310, the insulator 100 is removed after the weld joint is formed. The insulator 100 may be removed by fracturing the body 102 of the insulator 100.

While aspects of the present disclosure have been particularly shown and described above, it will be understood by those skilled in the art that various additional aspects may be contemplated by the modification of the disclosed machines, systems and methods without departing from the spirit and scope of what is disclosed. Such aspects should be understood to fall within the scope of the present disclosure as determined based upon the claims and any equivalents thereof.

What is claimed is:

1. An insulator for welding a boss onto a member, the insulator comprising:
a body comprising a first surface and a second surface, the second surface having a first curved profile;
a bore extending between the first surface and the second surface to define an inner wall of the body; and
a protrusion in the inner wall proximal to the second surface, the protrusion having a second curved profile.

2. The insulator of claim 1, wherein the second curved profile is identical to the first curved profile.

3. The insulator of claim 1, wherein the body comprises a first section having a first diameter and a second section having a second diameter, and wherein the first surface is part of the first section and the second surface is part of the second section.

4. The insulator of claim 3, wherein the second diameter is greater than the first diameter.

5. The insulator of claim 1 further comprising a plurality of ridges defined in at least a portion of the second surface.

6. The insulator of claim 5, wherein the plurality of ridges are defined in a half portion of the second surface.

7. The insulator of claim 5, wherein the plurality of ridges are semi-circular in shape.

8. The insulator of claim 1, wherein the body is made of ceramic material.

9. The insulator of claim 1 configured to support the boss, along a longitudinal axis, inside the bore, for welding the boss onto the member.

10. The insulator of claim 1, wherein the member comprises a curved surface, and wherein the first curved profile substantially conforms to the curved surface.

11. A method of welding a boss onto a member, the method comprising:
providing an insulator comprising:
a body comprising a first surface and a second surface, the second surface having a first curved profile;
a bore extending between the first surface and the second surface to define an inner wall of the body; and
a protrusion in the inner wall proximal to the second surface, the protrusion having a second curved profile;
placing the insulator with the second surface in contact with the member;
supporting the boss, along a longitudinal axis, inside the bore of the insulator; and
forming a weld joint between the boss and the member.

12. The method of claim 11 further comprising, heating the boss to at least a weld temperature to form the weld joint.

13. The method of claim 12, further comprising allowing hot gases formed inside the insulator due to heating to escape via a plurality of ridges defined in at least a portion of the second surface.

14. The method of claim 11 further comprising, removing the insulator after the weld joint is formed.

15. The method of claim 11, wherein the member includes a curved surface, and wherein the second surface is placed in contact with the member such that the second surface conforms to the curved surface of the member.

16. The method of claim 11, wherein the body of the insulator is made of ceramic material.

17. An insulator for welding a boss onto a curved surface of a member, the insulator comprising:
a body comprising a first section and a second section, the first section comprising a first surface and the second section comprising a second surface, the second surface having a first curved profile;
a plurality of ridges defined in at least a portion of the second surface, the plurality of ridges being substantially semi-circular in shape;
a bore extending between the first surface and the second surface to define an inner wall of the body; and
a protrusion in the inner wall proximal to the second surface, the protrusion having a second curved profile.

18. The insulator of claim 17, wherein the second curved profile is identical to the first curved profile.

19. The insulator of claim 17, wherein the first section has a first diameter and the second section has a second diameter, the second diameter being greater than the first diameter.

20. The insulator of claim 17, wherein the body is made of ceramic material.
